(19) United States
(12) Patent Application Publication
(10) Pub. No.: US 2010/0030719 A1
(43) Pub. Date: Feb. 4, 2010

(54) METHODS AND APPARATUS RELATED TO BIOINFORMATICS DATA ANALYSIS

(76) Inventors: Todd M. Covey, San Carlos, CA (US); Erik Evensen, Foster City, CA (US); Santosh K. Putta, Foster City, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/538,643

(22) Filed: Aug. 10, 2009

Related U.S. Application Data
(63) Continuation-in-part of application No. 12/501,274, filed on Jul. 10, 2009.
(60) Provisional application No. 61/087,555, filed on Aug. 8, 2008.
(60) Provisional application No. 61/153,627, filed on Feb. 18, 2009.
(60) Provisional application No. 61/079,551, filed on Jul. 10, 2008.
(60) Provisional application No. 61/087,555, filed on Aug. 8, 2008.
(60) Provisional application No. 61/153,627, filed on Feb. 18, 2009.
(60) Provisional application No. 61/079,537, filed on Jul. 10, 2008.

(51) Int. Cl. G06N 5/02; G06F 17/30

(52) U.S. Cl. 706/48; 707/104.1; 707/E17.044

(57) ABSTRACT

In one embodiment, one or more processor-readable media can be configured to store code representing instructions that when executed by one or more processors can cause the one or more processors to select a first relationship rule based on a first combination of parameters including a first parameter, and based on a hierarchical position of the first parameter within a hierarchical structure of a set of parameters from a biological category. A first statistical value can be defined based on a plurality of test values and based on the first relationship rule. A second statistical value can be defined based on a second relationship rule and based on a second combination of parameters. The second relationship rule can be selected based on a hierarchical position of the second parameter within the hierarchical structure of the set of parameters.

### RELATED APPLICATIONS

This application claims priority to and the benefit of U.S. Provisional Patent Application No. 61/087,555, filed on Aug. 8, 2008, entitled “System and Method for Providing a Bioinformatics Database,” and claims priority to and the benefit of U.S. Provisional Patent Application No. 61/153,627, filed on Feb. 18, 2009, entitled “Methods and Apparatus Related to Management of Experiments,” both of which are incorporated herein by reference in their entireties.

This application is a continuation-in-part of co-pending U.S. patent application Ser. No. 12/501,274, filed on Jul. 10, 2009, entitled “Methods and Apparatus Related to Management of Experiments” ('274 patent application), which claims priority to and the benefit of U.S. Provisional Patent Application No. 61/079,551, filed on Jul. 10, 2008, entitled “Systems and Methods for Experimental Design, Layout and Inventory Management” ('551 patent application), of U.S. Provisional Patent Application No. 61/087,555, filed on Aug. 8, 2008, entitled “System and Method for Providing a Bioinformatics Database” ('555 patent application), of U.S. Provisional Patent Application No. 61/153,627, filed on Feb. 18, 2009, entitled “Methods and Apparatus Related to Management of Experiments” ('627 patent application), and of U.S. Provisional Patent Application No. 61/079,537, filed on Jul. 10, 2008, entitled “Method and System for Data Extraction and Visualization of Multi-Parametric Data” ('537 patent application), all of which are incorporated herein by reference in their entireties.

### BACKGROUND

Embodiments described herein relate generally to methods and apparatus for analyzing data included in a bioinformatics database.

Research in many fields such as molecular biology, biochemistry, can require organization and analysis of complex experiments that involve many variables, such as, various equipments types with different limitations, numerous reactants that may have subtle incompatibilities, intricate testing and preparation procedures, and so forth. Known techniques for defining and organizing these types of complex experiments can be relatively inefficient, inaccurate, and unscalable. In addition, analyzing data produced by these complex experiments based on known techniques can be difficult. Thus, a need exists for methods and apparatus to address the shortfalls of present technology and to provide other new and innovative features.

### SUMMARY

In one embodiment, one or more processor-readable media can be configured to store code representing instructions that when executed by one or more processors can cause the one or more processors to select a first relationship rule based on a first combination of parameters including a first parameter, and based on a hierarchical position of the first parameter within a hierarchical structure of a set of parameters from a biological category. A first statistical value can be defined based on a plurality of test values and based on the first relationship rule. A second statistical value can be defined based on a second relationship rule and based on a second combination of parameters. The second relationship rule can be selected based on a hierarchical position of the second parameter within the hierarchical structure of the set of parameters.

### BRIEF DESCRIPTION OF THE DRAWINGS

FIG. 1A is a schematic diagram that illustrates a bioinformatics analysis module configured to analyze data stored in a bioinformatics database based on relationship rules, according to an embodiment.

FIG. 1B is a schematic diagram that illustrates data that can be stored in the bioinformatics database shown in FIG. 1A, according to an embodiment.

FIG. 2A is a schematic diagram that illustrates hierarchical structures of sets of parameters included in categories that can be processed at a bioinformatics analysis module, according to an embodiment.

FIG. 2B is a schematic diagram that illustrates annotation values and relationship rules associated with a parameter, according to an embodiment.

FIG. 3 is a schematic diagram that illustrates a hierarchical structure of a set of parameters modified based on an annotation value, according to an embodiment.

FIG. 4 is a flowchart that illustrates a method for calculating statistical values based on relationship rules, according to an embodiment.

### DETAILED DESCRIPTION

In some embodiments, a bioinformatics analysis module can be configured to analyze data stored in a bioinformatics database based on one or more relationship rules. The bioinformatics analysis module can be configured to select the one or more relationship rules based on one or more combinations of parameters (e.g., supersets of parameter combinations, subsets of parameter combinations). The combination(s) of parameters can be associated with one or more test values (e.g., experimentally measured values, fluorescence values) that can be used to calculate one or more statistical values based on the relationship rule(s). In some embodiments, the test value(s) can be associated with one or more test substance(s) that have attributes represented by the parameters included in the combination(s) of parameters. In some embodiments, one or more of the parameters can be from one or more sets of parameters that define one or more hierarchical structures within categories of data. In some embodiments, for example, the hierarchical structure(s) can be used by the bioinformatics analysis module to select the relationship rule(s). In some embodiments, the relationships rule(s) can be configured to trigger calculations of statistical values that are representative of, or correspond with, biological interactions associated with attributes represented by parameters included in a combination of parameters. In some embodiments, selection and/or use of relationship rule(s) by the bioinformatics analysis module can be triggered when the hierarchical structure(s) and/or the combination(s) of parameters are modified.

The following publications are hereby incorporated by reference in this patent application in their entireties:
Haskell et al., Cancer Treatment, 5^{th} Ed., W.B. Saunders and Co., 2001;
Alberts et al., The Cell, 4th Ed., Garland Science, 2002;
Vogelstein and Kinzler, The Genetic Basis of Human Cancer, 2d Ed., McGraw Hill, 2002;
Michael, Biochemical Pathways, John Wiley and Sons, 1999;
Weinberg, The Biology of Cancer, 2007; Immunobiology, Janeway et al. 7th Ed.;
Garland, Leroith and Bondy, Growth Factors and Cytokines in Health and Disease, A Multi Volume Treatise, Volumes 1A and IB, Growth Factors, 1996;
Shapiro, Howard M., Practical Flow Cytometry, 4th Ed., John Wiley & Sons, Inc., 2003;
H. Rashidi and K. Buehler, Bioinformatics Basics: Applications in Biological Science and Medicine (CRC Press, London, 2000);
Bioinformatics: A Practical Guide to the Analysis of Genes and Proteins (B. F. Ouelette and A. D. Baxevanis, eds., Wiley & Sons, Inc.; 2d ed., 2001);
High-content single-cell drug screening with phosphospecific flow cytometry, Krutzik et al., Nature Chemical Biology, 23 Dec. 2007;
Irish et al., Flt3 Y591 duplication and Bcl-2 over expression are detected in acute myeloid leukemia cells with high levels of phosphorylated wild-type p53, Neoplasia, 2007;
Irish et al. Mapping normal and cancer cell signaling networks: towards single-cell proteomics, Nature, Vol. 6 146-155, 2006;
Irish et al., Single cell profiling of potentiated phospho-protein networks in cancer cells, Cell, Vol. 118, 1-20 Jul. 23, 2004;
Schulz, K. R., et al., Single-cell phospho-protein analysis by flow cytometry, Curr Protoc Immunol, 2007, 78:8 8.17.1-20;
Krutzik, P. O., et al., Coordinate analysis of murine immune cell surface markers and intracellular phosphoproteins by flow cytometry, J. Immunol. 2005 Aug. 15, 175(4):2357-65;
Krutzik, P. O., et al., Characterization of the murine immunological signaling network with phosphospecific flow cytometry, J. Immunol. 2005 Aug. 15, 175(4):2366-73;
Shulz et al., Current Protocols in Immunology 2007, 78:8.17.1-20;
Stelzer et al., Use of Multiparameter Flow Cytometry and Immunophenotyping for the Diagnosis and Classification of Acute Myeloid Leukemia, Immunophenotyping, Wiley, 2000; and
Krutzik, P. O. and Nolan, G. P., Intracellular phospho-protein staining techniques for flow cytometry: monitoring single cell signaling events, Cytometry A. 2003 October, 55(2):61-70.

The following patents are hereby incorporated by reference in this patent application in their entireties: U.S. Pat. No. 7,381,535 and U.S. Pat. No. 7,393,656. The following patent applications are also hereby incorporated by reference in this patent application in their entireties: U.S. Ser. No. 10/193,462; U.S. Ser. No. 11/655,785; U.S. Ser. No. 11/655,789; U.S. Ser. No. 11/655,821; U.S. Ser. No. 11/338,957; U.S. Ser. No. 61/048,886; U.S. Ser. No. 61/048,920; U.S. Ser. No. 61/048,657; U.S. Ser. No. 61/079,766; and U.S. Ser. No. 61/079,579.

Some commercial reagents, protocols, software and instruments that can be used in at least some of the embodiments described herein can be accessed at the Becton Dickinson website at http://www.bdbiosciences.com/features/products/, the Beckman Coulter website at http://www.beckmancoulter.com/Default.asp?bhfv=7, and Cell Signaling Technology's website at http://www.cellsignal.com. Experimental and process protocols and other information can be found at http://proteomics.stanford.edu and http://facs.stanford.edu.

As used in this application, the singular forms “a,” “an,” and “the” include plural references unless the context clearly dictates otherwise. For example, the term “a biological sample” can include a plurality of biological samples, including mixtures thereof. In some embodiments, an individual is not limited to a human being but may also be other organisms including, but not limited to mammals, plants, bacteria, or cells derived from any of the above.

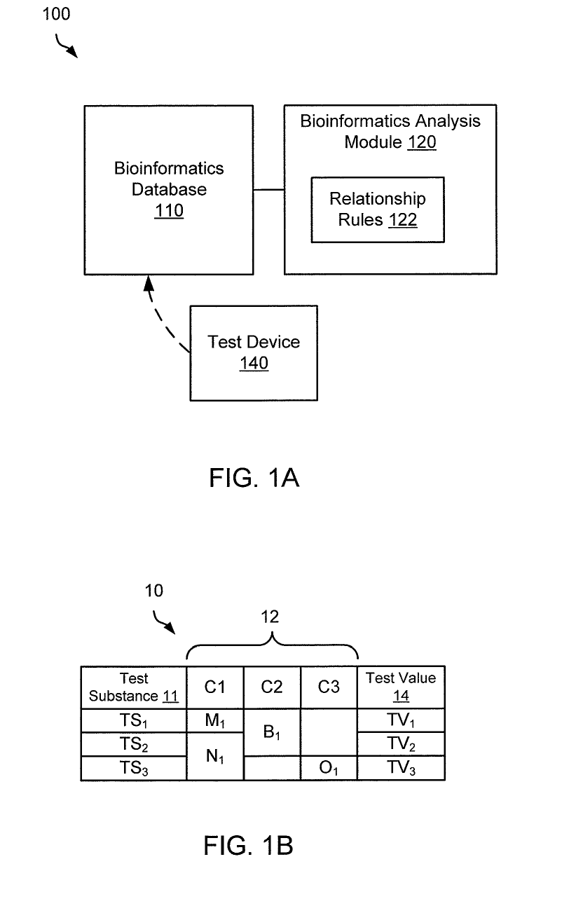

FIG. 1A is a schematic diagram that illustrates a bioinformatics analysis module 120 configured to analyze data stored in a bioinformatics database 110 based on relationship rules 122, according to an embodiment. Specifically, the bioinformatics analysis module 120 can be configured to access one or more test values (e.g., experimentally measured values, fluorescence values, mass values) stored in the bioinformatics database 110 and can be configured to calculate one or more statistical values based on the test value(s). In some embodiments, the test value(s) can be associated with one or more test substances.

In some embodiments, the bioinformatics database 110 can be, for example, a relational database, a distributed database, a set of linked tables, and/or so forth. Although not shown, the bioinformatics database 110 can include any type of memory component such as a random-access memory (RAM) component, a hard drive, a removable memory component and/or so forth. Although not shown, in some embodiments, the bioinformatics database 110 can include other components that can facilitate access to data stored in the bioinformatics database 110 such as, for example, a processor and/or an access module. In some embodiments, one or more portions of the bioinformatics database 110 can be accessed via a wired network and/or wireless network (not shown). Accordingly, the bioinformatics database 110 can be a remote database (e.g., non-local databases) accessed through one or more terminals and/or through one or more machines accessed through an intranet or internet.

FIG. 1B is a schematic diagram that illustrates data 10 that can be stored in the bioinformatics database 110 shown in FIG. 1A, according to an embodiment. As shown in FIG. 1B, the data 10 includes test values 14 (which includes test value TV₁, test value TV₂, and test value TV₃) and categories 12 (which includes category C1, category C2, and category C3) of parameters. In this embodiment, the test value TV₁ is associated with the combination of parameter M₁ from category C1 and parameter B₁ from category C2, and the test value TV₂ is associated the combination of parameter N₁ from category C1 and parameter B₁ from category C2. Test value TV₁ is associated with test substances TS₁, and test value TV₂ is associated with test substances TS₂. As shown in FIG. 1B, test value TV₃ is associated with test substance TS₃, which can be characterized by parameter N₁ (which is included in category C1) and parameter O₁ (which is included in category C3), but is not characterized by a parameter included in category C2. The parameters within the categories 12 can be referred to as a set of parameters. For example, parameter M₁ and parameter N₁ define a set of parameters included in category C1.

In some embodiments, the parameters can represent, for example, attributes (e.g., characteristics) of one or more test substances 11 within the categories 12. Specifically, a combination of the parameters can be used to characterize the test substances 11. The test values 14 can represent values measured based on an experiment conducted at, for example, test device 140 (shown in FIG. 1A) using the test substances. Thus, the data 10 can represent experimental data related to test substances 11 that have specified attributes (or characteristics). In some embodiments, at least a portion of the data 10 (e.g., test values 14) can be output test data from the test device 140. For example, in some embodiments, the test values 14 can include, for example, signaling data measured at the test device 140. In some embodiments, the test values 14 can include, for example, a temperature measurement value, a pressure measurement value, a concentration measurement value, a time value, and/or so forth. In some embodiments, the test values 14 can represent a stimulus (e.g., an electrical pulse duration, a laser energy pulse power value) at the test device 140 and/or can represent a response of at least one of the test substances 11 (e.g., a cell) to a stimulus at the test device 140. In some embodiments, one or more portions of the data 10 can be defined based on, for example, an experiment file.

For example, parameter M₁ (shown in the column associated with category C1) can represent that test substance TS₁ is a liquid tumor such as a lymphoid type tumor or a myeloid type tumor, and the parameter N₁ (shown in the column associated with category C1) can represent that test substance TS₂ is a solid tumor such as a melanoma type tumor or a carcinoma type tumor. The parameter M₁ and the parameter N₁ can be included in a broad category such as a specimen category, which can be represented by category C1. Similarly, the parameter B₁ (shown in the column corresponding with category C2) can represent that test substance TS₂ includes a growth factor such as Granulocyte Colony-Stimulating Factor (G-CSF), which can be included in a broad category such as a reagent (e.g., stimulant, modulator, stain) category (which can be represented by category C2). Thus, the test value TV₁ (shown in column test value 14) can be a value measured at the test device 140 from an experiment involving test substance TS₁ which is a combination of a specimen (shown as category C1) that is a lymphoid type tumor (which is represented by parameter M₁) with a reagent (shown as category C2) that is a growth factor G-CSF (which is represented by parameter B₁). In some embodiments, the categories of data stored in the bioinformatics database 110 (shown in FIG. 1A) can be or can include, for example, a kinetic category that includes parameters related to kinetic velocities (e.g., 5 minutes, 2 seconds) and/or a protein category that includes parameters related to proteins associated with a signaling pathway (e.g., p-Akt, Jak/Stat pathway). In some embodiments, the categories 12 can be mutually exclusive categories.

Referring back to FIG. 1B, in some embodiments, the categories 12 and/or the parameters included in the categories 12 can be pre-defined. For example, the categories 12 and/or the parameters included in the categories 12 can be defined by a user when the structure (e.g., architecture) of the bioinformatics database 110 is defined. In some embodiments, the categories 12 and/or the parameters included in the categories 12 can be defined based on empirical knowledge about, for example, biological relationships and/or interactions between one or more of the categories and/or the parameters included in the categories 12. In some embodiments, the categories 12 and/or the parameters included in the categories 12 can be defined based on, for example, attributes associated one or more test substances. More details related to the data and type of data that can be included in the bioinformatics database 110 are described in the '555 patent application, which is incorporated herein by reference in its entirety.

Referring back to FIG. 1A, in some embodiments, the test device 140 can be, for example, a stress test device, a flow cytometer (e.g., a four-color fluorescence capable flow cytometer such as a FACScalibur flow cytometer, or higher color capability flow cytometers, such and LSR II or FACS Canto II), a mass spectrometer (e.g., an inductively coupled plasma mass spectrometer (ICP-MS) device such as a PerkinElmer SCIEX or an Applied Biosystems QTRAP, Triple Quad, or TOF/TOF system), a mass cytometer (e.g., a DVS Sciences CyTOF™ device), a device configured to test various assays (Enzyme Linked Immuno-Sorbent Assays (ELISA), protein and cell growth assays, assays for molecular interactions, enzyme activity assays, cell toxicity assays, immunoassays, and high throughput screening of compounds and targets in drug discovery such as FLIPR assays), a nucleic acid hybridization and/or amplification device (e.g., a Roche molecular analysis device, a HandyLab molecular diagnostic system), and so forth. In some embodiments, any portion of a substance (e.g., a material) to be used during an experiment (e.g., during preparation, during testing at a test device, a quality control portion of an experiment) can be referred to as a test substance (or test material) or as a target substance (or target material).

In some embodiments, if the test device 140 is a flow cytometer, the flow cytometer can be configured to count, examine, and/or sort microscopic particles, such as single cells, suspended in a stream of fluid. The flow cytometer can be configured to simultaneously perform multi-parametric analysis of physical and/or chemical characteristics of single cells flowing through an optical and/or electronic detection apparatus. In some embodiments, the flow cytometer can be configured to measure properties related to individual cells. In some embodiments, a liquid stream in the flow cytometer can be configured to carry and/or align individual cells so that they pass through a laser beam in single file. As a cell passes through a light beam (usually laser light), light can be scattered from the cell surface. Photomultiplier tubes can be configured to collect the light scattered in the forward and side directions which can give information related to the cell size and/or shape. This information may be used to identify the general type of cell (e.g. monocyte, lymphocyte, or granulocyte). In some embodiments, a flow cytometer can include multiple light sources and/or detectors.

In some embodiments, fluorescent molecules (fluorophores) can be conjugated with antibodies and associated with components of a cell that are analyzed by a flow cytometer and output as data that can be stored at the bioinformatics database 110 and processed by the bioinformatics analysis module 120. Fluorophores can be activated by the laser and re-emit light of a different wavelength. Since these antibodies can bind to antigens in or around the cells, the amount of light detected from the fluorophores is related to the number of antigens associated with the cell passing through the beam. Any specific set of fluorescently tagged antibodies in any embodiment can depend on the types of cells to be studied. Several tagged antibodies can be used simultaneously, so measurements made as one cell passes through the laser beam consist of scattered light intensities as well as emitted light intensities from each of the fluorophores. Thus, the characterization of a single cell can consist of a set of measured light intensities that may be represented as a coordinate position in a multidimensional space. Considering only the light from the fluorophores, there is one coordinate axis corresponding to each of the fluorescently tagged antibodies. The number of coordinate axes (the dimension of the space) is the number of fluorophores used. Modern flow cytometers can measure several colors associated with different fluorophores and thousands of cells per second. Thus, the data from one subject can be described by a collection of measurements related to the number of antigens for each of (typically) many thousands of individual cells. Any portion of the output data (e.g., characteristics related to test substances, fluorescence values, measured values, cells counts, coordinate space information) from the flow cytometer described above can be stored in, for example, the bioinformatics database 110. More details related to data produced by a flow cytometer are described in a the '274 patent application, which is incorporated by reference herein in its entirety.

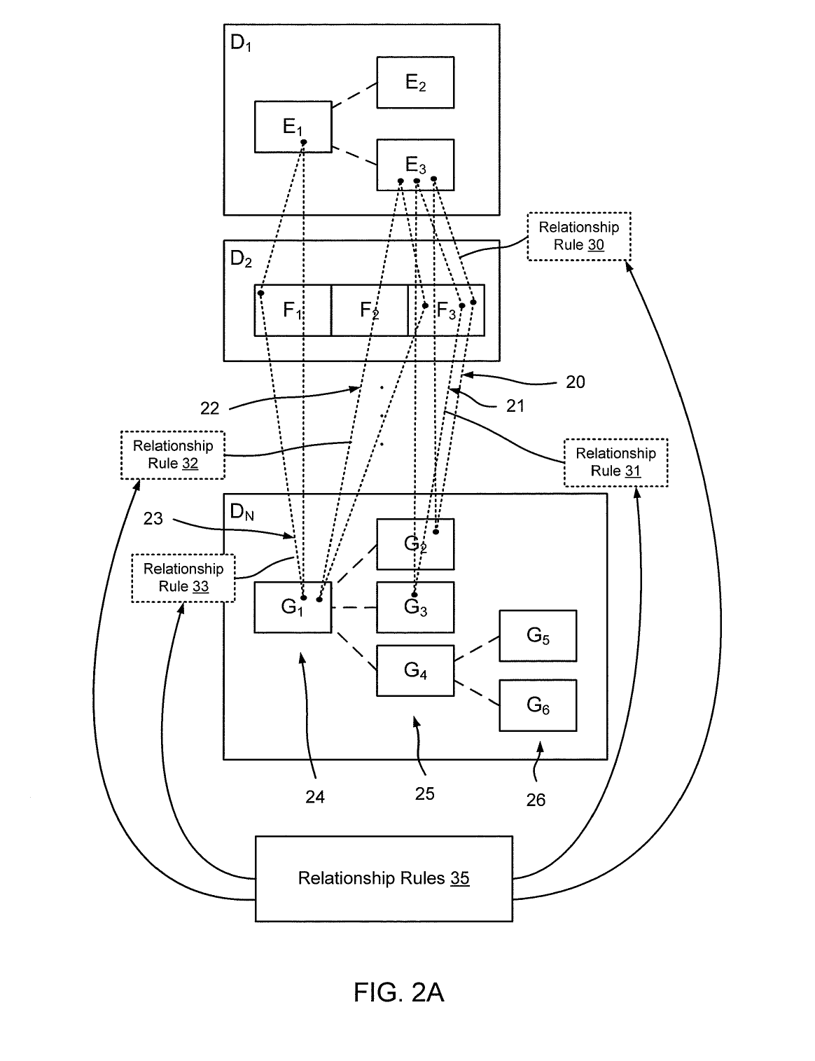

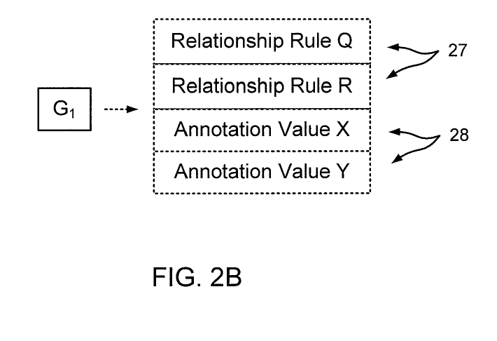

As shown in FIG. 1A, at least a portion of data stored in the bioinformatics database 110 can be from (e.g., derived from) a variety of data sources that can be separate from the test device 140. For example, information (e.g., categories, parameters, test values) stored in the bioinformatics database 110 can be from, for example, documentation related to test substances (e.g., common test substances) and/or testing substrates. In some embodiments, at least a portion of the bioinformatics database 110 can be linked to other databases (e.g., inventory databases, attribute databases) so that information related to, for example, inventory items included in a physical inventory (and/or inventory items that could be included in the physical inventory) can be retrieved from the other databases and included in (e.g., used to update) the bioinformatics database 110. In some embodiments, the bioinformatics database 110 can be configured to receive information that is stored in an antibody database and/or a fluorescent dye database. The information can subsequently be included in (e.g., stored in, used to update) the bioinformatics database 110. In some embodiments, the information (e.g., information related to inventory items such as reagents, antibodies, and/or fluorophores) in the bioinformatics database 110 can be automatically refreshed and/or updated based on information from various companies on an ad hoc, as needed, random and/or regular basis (e.g., continually). In some embodiments, data stored in the bioinformatics database can be associated with, for example, equipment related to a test substance. In some embodiments, one or more portions of the bioinformatics database 110 can be defined based on a know-how and/or empirical data that can be input by a user. In some embodiments, the bioinformatics database 110 can be or can be derived from, for example, an attribute database and/or an inventory database such as those described in the '274 patent application, which is incorporated by reference herein in its entirety. Additional details relate to the type of data that can be stored in the bioinformatics database 110 are described before FIG. 2A below.

In this embodiment, the bioinformatics analysis module 120 (shown in FIG. 1A) can be configured to calculate a statistical value based on a mathematical combination of, for example, the test value TV₁ and the test value TV₂ (shown in FIG. 1B). In other words, the test value TV₁ and the test value TV₂ can be aggregated into a single value. The statistical value calculated based on test value TV₁ (which is associated with test substance TS₁) and test value TV₂ (which is associated with test substance TS₂) can be representative of, for example, chemical interactions observed in test substances TS₁ and TS₂, which have characteristics (represented by parameters) associated with category C1 and category C2. In some embodiments, a statistical value may not be a combination of test values 14. For example, a statistical value can correspond to a single test value such as test value TV₃. In some embodiments, multiple test values (e.g., test values 14) can be aggregated into multiple statistical values. In some embodiments, the number of statistical values can be equal to or more than the number of test values used to define the statistical values.

The bioinformatics analysis module 120 can be configured to calculate one or more statistical values using the test values 14 (shown in FIG. 1B) based on a relationship rule from the relationship rules 122. The relationship rule can be selected from the relationship rules 122 (e.g., library of relationship rules) based on the combination of parameters associated with the test values 14 and also associated with the test substances 11. For example, a relationship rule can be selected from the relationship rules 122 based on a combination of parameters that are included in certain of the categories 12. The relationship rules 122 can define a manner (e.g., an order, an algorithm) in which statistical values should be calculated based on the test values 14.

In some embodiments, the data 10 (or information that can be stored in the bioinformatics database 110) can be arranged based on a hierarchical structure. In some embodiments, one or more relationship rules 122 can be selected based on the hierarchical structure, and the selected relationship rule(s) can be used to define a statistical value. More detail related to hierarchical structures, selection of relationship rules, and so forth are described in connection with FIG. 2A through FIG. 4. In some embodiments, the data 10 (or other data that is not shown) may not be hierarchically arranged. In other words, the bioinformatics analysis module 120 can be configured to analyze data (e.g., at least a portion of data) that does not define a hierarchy based one or more of the relationship rules 122.

In some embodiments, one or more portions of the bioinformatics database 110 and/or the bioinformatics analysis module 120 can be associated with (e.g., included in, in communication with, coupled to) an experiment management engine (not shown). For example, the bioinformatics database 110 and/or the bioinformatics analysis module 120 can be integrated into a system that includes the experiment management engine. In some embodiments, one or more portions of the bioinformatics database 110 and/or the bioinformatics analysis module 120 can be accessed (e.g., controlled, managed) by a user via a user interface (not shown). More details related to an experiment management engine and/or a user interface are described in at least the '274 patent application, which is incorporated herein by reference in its entirety.

In some embodiments, a test substance can include, for example, one or more specimen (e.g., a single specimen, a combination of specimen) and/or one or more reagents that are a target of processing at the test device 140. In some embodiments, a specimen can be referred to as a sample. In some embodiments, the specimen can be, for example, a biological specimen (e.g., a blood sample or fraction thereof, bone marrow, a tissue sample). In some embodiments, the specimen can be, for example, a chemical specimen (e.g., a salt compound, a chemical compound such as an anticancer drug) that is not a biological specimen and/or is not organic in nature. In some embodiments, the test substance can be one or more specimen not combined with a reagent.

In some embodiments, a reagent included in a test substance can be configured (e.g., formulated) to influence processing of the specimen at the test device 140. The reagent can be, for example, a stimulant/modulator (e.g., a modulator configured to activate an activatable pathway in a cell, a drug), a detection element (e.g., an antibody coupled to a fluorescent label, a stain, a detection element), an antibody, a buffer, and so forth. For example, in some embodiments, the reagent can be included in the test substance so that a characteristic of the sample included in the test substance can be detected in a desirable fashion when the test substance is being processed at the test device 140.

In some embodiments, a reagent (e.g., a modulator) can be, for example, one or more of growth factors, cytokines, adhesion molecules, drugs, hormones, small molecules, polynucleotides, antibodies, natural compounds, lactones, chemotherapeutic agents, immune modulators, carbohydrates, proteases, ions, reactive oxygen species, peptides, and protein fragments, either alone or in the context of cells, cells themselves, viruses, and biological and non-biological complexes (e.g. beads, plates, viral envelopes, antigen presentation molecules such as major histocompatibility complex) F(ab)2 IgM, PMA, BAFF, April, SDF 1 a, CD40L, IGF-1, Imiquimod, polyCpG, IL-7. In another embodiment, a reagent can be, for example, hydrogen peroxide (H₂O₂), siRNA, miRNA, Cantharidin, (−)-p-Bromotetramisole, Microcystin LR, Sodium Orthovanadate, Sodium Pervanadate, Vanadyl sulfate, Sodium oxodiperoxo(1, 1 0-phenanthroline)vanadate, bis(maltolato)oxovanadium(IV), Sodium Molybdate, Sodium Perm olybdate, Sodium Tartrate, Imidazole, Sodium Fluoride, PGlycerophosphate, Sodium Pyrophosphate Decahydrate, Calyculin A, Discodermia calyx, bpV(phen), mpV(pic), DMHV, Cypermethrin, Dephostatin, Okadaic Acid, NIPP-1, N-(9,10-Dioxo-9,10-dihydro-phenanthren-2-yl)-2,2-dimethyl-pr0pi0namidae-B, romo-4-hydroxyacetophenone, 4-Hydroxyphenacyl Br, a-Bromo-4-methoxyacetophenone, 4-Methoxyphenacyl Br, a-Bromo-4-(carboxymethoxy)acetophenone, 4-(Carboxymethoxy)phenacyl Br, and bis(4-Trifluoromethylsulfonamidophenyl)-1,4-diisopropylbenzene, phenyarsine oxide, Pyrrolidine Dithiocarbamate, and Aluminium fluoride, kinases, phosphatases, lipid signaling molecules, adaptor/scaffold proteins, cytokines, cytokine regulators, ubiquitination enzymes, adhesion molecules, cytoskeletal/contractile proteins, heterotrimeric G proteins, small molecular weight GTPases, guanine nucleotide exchange factors, GTPase activating proteins, caspases, proteins involved in apoptosis, cell cycle regulators, molecular chaperones, metabolic enzymes, vesicular transport proteins, hydroxylases, isomerases, deacetylases, methylases, demethylases, tumor suppressor genes, proteases, ion channels, molecular transporters, transcription factors 1 DNA binding factors, regulators of transcription, and regulators of translation. In some embodiments, a reagent can be an activateable element such as, for example, HER receptors, PDGF receptors, Kit receptor, FGF receptors, Eph receptors, Trk receptors, IGF receptors, Insulin receptor, Met receptor, Ret, VEGF receptors, TIE1, TIE2, FAK, Jak1, Jak2, Jak3, Tyk2, Src, Lyn, Fyn, Lck, Fgr, Yes, Csk, Abl, Btk, ZAP70, Syk, IRAKs, cRaf, ARaf, BRAF, Mos, Lim kinase, ILK, Tpl, ALK, TGFP receptors, BMP receptors, MEKKs, ASK, MLKs, DLK, PAKs, Mek 1, Mek 2, MKK316, MKK417, ASKI, Cot, NIK, Bub, Myt 1, Weel, Casein kinases, PDK1, SGK1, SGK2, SGK3, Akt1, Akt2, Akt3, p90Rsks, p70S6Kinase, Prks, PKCs, PKAs, ROCK 1, ROCK 2, Auroras, CaMKs, MNKs, AMPKs, MELK, MARKS, Chk1, Chk2, LKB-1, MAPKAPKs, Pim1, Pim2, Pim3, IKKs, Cdks, Jnks, Erks, IKKs, GSK3a, GSK3P, Cdks, CLKs, PKR, P13-Kinase class 1, class 2, class 3, mTor, SAPWJNK1,2,3, p38s, PKR, DNA-PK (DNA-PKcs, Ku70, Ku80), ATM, ATR, Receptor protein tyrosine phosphatases (RPTPs), LAR phosphatase, CD45, Non receptor tyrosine phosphatases (NPRTPs), SHPs, MAP kinase phosphatases (MKPs), Dual Specificity phosphatases (DUSPs), CDC25 phosphatases, Low molecular weight tyrosine phosphatase, Eyes absent (EYA) tyrosine phosphatases, Slingshot phosphatases (SSH), serine phosphatases, PP2A, PP2B, PP2C, PP1, PP5, inositol phosphatases, PTEN, SHIPS, myotubularins, phosphoinositide kinases, phopsholipases, prostaglandin synthases, 5-lipoxygenase, sphingosine kinases, sphingomyelinases, adaptorlscaffold proteins, Shc, Grb2, BLNK, LAT, B cell adaptor for PI3-kinase (BCAP), SLAP, Dok, KSR, MyD88, Crk, CrkL, GAD, Nck, Grb2 associated binder (GAB), Fas associated death domain (FADD), TRADD, TRAF2, RIP, T-cell leukemia family, IL-2, IL-4, IL-8, IL-6, interferon y, interferon a, suppressors of cytokine signaling (SOCs), Cb1, SCF ubiquitination ligase complex, APCIC, adhesion molecules, integrins, Immunoglobulin-like adhesion molecules, selectins, cadherins, catenins, focal adhesion kinase, p130CAS, fodrin, actin, paxillin, myosin, myosin binding proteins, tubulin, eg5/KSP, CENPs, P-adrenergic receptors, muscarinic receptors, adenylyl cyclase receptors, small molecular weight GTPases, H-Ras, K-Ras, N-Ras, Ran, Rac, Rho, Cdc42, Arfs, RABs, RHEB, Vav, Tiam, Sos, Db1, PRK, TSC1,2, Ras-GAP, Arf-GAPS, Rho-GAPS, caspases, Caspase 2, Caspase 3, Caspase 6, Caspase 7, Caspase 8, Caspase 9, Bcl-2, Mc1-1, Bcl-XL, Bcl-w, Bcl-B, A1, Bax, Bak, Bok, Bik, Bad, Bid, Bim, Bmf, Hrk, Noxa, Puma, IAPs, XIAP, Smac, Cdk4, Cdk 6, Cdk 2, Cdk1, Cdk 7, Cyclin D, Cyclin E, Cyclin A, Cyclin B, Rb, p16, p14Arf, p27KIP, p21CIP, molecular chaperones, Hsp90s, Hsp70, Hsp27, metabolic enzymes, Acetyl-CoAa Carboxylase, ATP citrate lyase, nitric oxide synthase, caveolins, endosomal sorting complex required for transport (ESCRT) proteins, vesicular protein sorting (Vsps), hydroxylases, prolyl-hydroxylases PHD-1, 2 and 3, asparagine hydroxylase FIH transferases, Pin1 prolyl isomerase, topoisomerases, deacetylases, Histone deacetylases, sirtuins, histone acetylases, CBP1P300 family, MYST family, ATF2, DNA methyl transferases, Histone H3K4 demethylases, H3K27, JHDM2A, UTX, VHL, WT-1, p53, Hdm, PTEN, ubiquitin proteases, urokinase-type plasminogen activator (uPA) and uPA receptor (uPAR) system, cathepsins, metalloproteinases, esterases, hydrolases, separase, potassium channels, sodium channels, multi-drug resistance proteins, P-Glycoprotein, nucleoside transporters, Ets, Elk, SMADs, Rel-A (p65-NFKB), CREB, NFAT, ATF-2, AFT, Myc, Fos, Sp1, Egr-1, Tbet, p-catenin, HIFs, FOXOs, E2Fs, SRFs, TCFs, Egr-1, FOX0 STAT1, STAT 3, STAT 4, STAT 5, STAT 6, p53, WT-1, HMGA, pS6, 4EPB-1, eIF4E-binding protein, RNA polymerase, initiation factors, elongation factors, Bevacizumab, FG-22 16; Ezatiostat; Clofarabine; growth factor therapy, such as G-CSF, GM-CSF, IL-3, EPO, EPO plus G-CSF, Hematide, thrombopeitin; Immunosuppressive agents such as Cyclosporine, Anti-thymocyte globulin agents; Receptor tyrosine kinase inhibitors such as, AG3340, SCIO-469; Gleevec, Sorafenib; survival signal inhibitors such as Farnesyl transferase inhibitors Tipifarnib and Lonafarnib; pharmacologic differentiators, such as TLK199; thrombopoiesis-stimulating agents such as IL-11; Lenalidomide; Arsenic trioxide, alone or in combination with azacitidine or with tipifarnib and gemtuzumab ozogamicin; hypomethylating drugs, such as Azacitidine and Decitabine; histone deacetylase inhibitors, such as Vorinostat and valproic acid; or agents for the reversal of epigenetic gene silencing, apoptosis inhibition, immune modulation, angiogenesis inhibition; cytarabine and an anthracycline drug, such as, daunorubicin or idarubicin, and 6-thioguanine. In some embodiments, a reagent can be, for example, an element that when added to a biological sample, may cause a reaction in the sample, such as altering cellular components such as proteins, lipids, or nucleic acids, which can affect protein signaling networks or gene expression. Some reagents may also have fluorescent properties that may also be used as a stain. In some embodiments, a detection element (or stain) can be, for example, a molecule used for visualization and/or quantification of a molecule or a structure, especially in a cell. Examples of stains include antibodies, fluorochromes, and/or a combination thereof.

In some embodiments, information that can be stored in the bioinformatics database 110 can include, but is not limited to, information on the type of cells analyzed, the sample source, the method of obtaining the sample, the donor id, the sample line, the organization providing the source if applicable and the like. Examples of specimen (e.g., cell types) may include, but are not limited to, B cells, monocytes, T cells, Natural Killer Cells, cells from a specific disease type such as Acute Myeloid Leukemia (AML), neutrophils, CD34 and its progenitors, dendritic cells, and the like. A source of a specimen can include, but is not limited to, peripheral blood, smears, sputum, biopsies, secretions, cerebrospinal fluid, bile, sera, whole blood, ascites, plasma, cell extract, whole cells, lavage or rinse of cavities, lymph fluid, saliva, urine and feces, or tissue which has been removed from organs, such as breast, lung, intestine, skin, cervix, prostate, and stomach. The information could further include whether the specimen was a fraction of the above specimen or a derivative or preparation of the specimen or from other biological specimens. Other potential information could include whether the specimen was from peripheral blood mononuclear cells (PBMC), bone marrow derived mast cells (BMMC), fresh bone marrow (BM), frozen BMMC, and/or fractionated BMMC. The information stored in the bioinformatics database 110 may also include, but is not limited to, whether the specimen used were fresh, frozen, or cells derived from any specimen. These specimen can be collected by techniques such as bone marrow biopsy. These specimen may be directly collected at places such as the physician's office or provided by external groups such as cooperative groups, clinics, cancer centers, hospitals, drug development companies and the like. Appropriate collaborations can be established with the external groups, as and when required, to ensure the availability of various specimen.

Various information related to signaling pathways can also be stored in the bioinformatics database 110. Signaling pathways can include, but are not limited to, signaling pathways, such as NF-kB, PI3k/AKT, Wnt, PKC, MAP Kinase, Ras/RAF/MEK/ERK, JNK/SAPK, p38 MAPK, Src Family Kinases, JAK/STAT, Notch, Hedgehog, and may include representations of receptor signaling such as BCR (B cell Receptor), TNF Family of Receptors (including, but not limited to, TNFR, BAFF-R, TACI, BCMA, CD40, APRIL, etc.), Toll-like Receptor (TLR), CD 117 signaling [also known as KIT, c-Kit, Stem Cell Factor (SCF) induced c-kit signaling, SCF/c-kit signaling, or SCF-R (SCF-Receptor) signaling], Stromal cell-derived factor (SDF) signaling (including, but not limited to SDF-1 or CXCL12 ligand of CXCL4 receptor signaling, SDF-1a, SDF-1b, and SDF-9 IGF-1 signaling), and/or Growth factor receptor tyrosine kinase signaling. See U.S. Ser. No. 61/079,766, which is hereby incorporated by reference in its entirety for all purposes.

Although not shown, in some embodiments, the bioinformatics analysis module 120 and/or bioinformatics database 110 can be accessed via a user interface (e.g., a graphical user interface (GUI)). The user interface can be configured so that a user can send signals (e.g., control signals, input signals, signals related to instructions) to the bioinformatics analysis module 120 and/or bioinformatics database 110 and/or receive signals (e.g., output signals) from the bioinformatics analysis module 120 and/or bioinformatics database 110. Specifically, the user interface can be configured so that the user can trigger one or more functions to be performed (e.g., executed) at the bioinformatics analysis module 120 and/or bioinformatics database 110 via the user interface and/or receive an output signal from the bioinformatics analysis module 120 and/or bioinformatics database 110 at, for example, a display (not shown) of the user interface. For example, in some embodiments, a user can manage (e.g., update, modify) at least a portion of the bioinformatics database 110 via the user interface. In some embodiments, the user interface can be a user interface associated with, for example, a personal computer and/or a server. For example, a variety of different combinations and implementations of GUIs may be used. In some embodiments, an inventory management GUI, a layout design GUI, and/or an experimental design GUI can be displayed on the user interface. More details related to a user interface are set forth in the '555 patent application, which has been incorporated herein by reference in its entirety.

In some embodiments, one or more portions of the bioinformatics analysis module 120 and/or bioinformatics database 110 can be a hardware-based module (e.g., a digital signal processor (DSP), a field programmable gate array (FPGA), a memory), a firmware module, and/or a software-based module (e.g., a module of computer code, a set of computer-readable instructions that can be executed at a computer). In some embodiments, one or more of the functions associated with the bioinformatics analysis module 120 and/or bioinformatics database 110 can be included in one or more different modules (not shown). In some embodiments, one or more portions of the bioinformatics analysis module 120 and/or bioinformatics database 110 can be a wired device and/or a wireless device (e.g., wi-fi enabled device) and can be, for example, a computing entity (e.g., a personal computing device), a mobile phone, a personal digital assistant (PDA), a server (e.g., a web server/host), and/or so forth. The bioinformatics analysis module 120 and/or bioinformatics database 110 can be configured to operate based on one or more platforms (e.g., one or more similar or different platforms) that can include one or more types of hardware, software, firmware, operating systems, runtime libraries, and so forth.

In some embodiments, a user interface (or portion of the user interface), the bioinformatics analysis module 120, the bioinformatics database 110, and/or the test device 140 (or portion of the test device 140) can be configured to communicate via a network (not shown). In some embodiments, the network can be, for example, a virtual network, a local area network (LAN) and/or a wide area network (WAN) and can include one or more wired and/or wireless segments. For example, the bioinformatics analysis module 120 can be accessed (e.g., manipulated) as a web-based service. Accordingly, the user interface can be, for example, a personal computer, and the bioinformatics analysis module 120 can be accessed via, for example, the Internet. In some embodiments, the bioinformatics analysis module 120 can be configured to facilitate communication (e.g., collaboration) between users (e.g., users at separate, remote locations).

FIG. 2A is a schematic diagram that illustrates hierarchical structures of sets of parameters included in categories that can be processed at a bioinformatics analysis module, according to an embodiment. Specifically, the categories include category D₁ through category D_{N}. In some embodiments, the categories can be biological categories. In some embodiments, for example, the categories can include, for example, a kinetic category, a specimen category, a protein category, a reagent (e.g., a modulator) category, and so forth. In some embodiments, the categories D₁ through D_{N} can be mutually exclusive categories or overlapping categories. Accordingly, the parameters can be mutually exclusive parameters that are only included in one category or can be included in multiple categories.

As shown in FIG. 2A, the category D₁ includes a set of parameters E₁ through E₃ that are arranged in a hierarchical structure. Specifically, parameter E₂ and parameter E₃ are on the same hierarchical level, and are related to parameter E₁, which is on a higher hierarchical level than the hierarchical level of parameter E₂ and parameter E₃. Accordingly parameter E₁ can be referred to as a parent parameter (e.g., parent node) or can be referred to as being in a parent hierarchical position within the hierarchical structure of the set of parameters included in category D₁. Parameter E₂ and parameter E₃ can be referred to as a child parameters (of the parent parameter), or can be referred to as being in a child hierarchical position within the hierarchical structure of the set of parameters included in category D₁. In some embodiments, the parameter E₂ and parameter E₃ can be referred to as terminating parameters because they are not above another hierarchical level of parameters. Other parameters that are not terminating parameters can be referred to as non-terminating parameters.

Similarly, as shown in FIG. 2A, the category D_{N} includes a set of parameters G₁ through G₆ that are arranged in a hierarchical structure. Specifically, parameter G₁ is at hierarchical level 24, parameter G₂, parameter G₃, and parameter G₄ are at hierarchical level 25, and parameter G₅ and parameter G₆ are at hierarchical level 26. Within the set of parameters included in category D_{N}, parameter G₂, parameter G₃, parameter G₅, and parameter G₆ are terminating parameters. The non-terminating parameters included in category D_{N} are parameter G₁ and parameter G₄.

As shown in FIG. 2A, the category D₂ includes a set of parameters F₁ through F₃ that are arranged in a linear hierarchical structure. Specifically, parameter F₁ is parent of parameter F₂, and parameter F₂ is a parent of parameter F₃. Accordingly, parameter F₃ can be considered a grandchild parameter of parameter F₁. Within the set of parameters included in category D₂, parameter F₃ is a terminating parameter.

In some embodiments, test values can be associated with only terminating parameters or with only non-terminating parameters. In some embodiments, test values can be associated with both terminating parameters and non-terminating parameters.

In some embodiments, the hierarchical structure of the parameters can be defined, for example, by a user based on information (e.g., biological information) related to parameters within a category. For example, parent parameters can be defined so that the child parameters of the parent parameters are included within the definition of the parent parameter. In other words, child parameters can be species of a parent parameter, which can function as a genus. For example, the category D_{N} can be a protein category and parameter G₁ can represent a cell growth parameter (e.g., a proliferation parameter, a cell death parameter). Parameter G₄ can represent a pathway parameter (e.g., a Jak/Stat pathway parameter, an akt-pathway), and parameter G₅ and parameter G₆ can respectively represent proteins included in the pathway parameter (e.g., Stat1, Stat3). In some embodiments, for example, the category D₁ can be a reagent category and parameter E₁ can represent a modulator type parameter (e.g., a growth factor type parameter, a cytokine type parameter, an inhibitor type parameter). If parameter E₁ is an inhibitor type parameter, parameter E₂ and parameter E₃ can respectively represent specific inhibitors (e.g., Gleevec). If parameter E₁ is a cytokine type parameter, parameter E₂ and parameter E₃ can respectively represent specific cytokines (e.g., IL-2, IL-6). In some embodiments, for example, category D₂ can be a kinetic category and parameters F₁ through F₃ can represent different kinetic time periods. Specifically, parameter F₃ can represent a relatively short time period, and parameter F₂ can represent a relatively long time period. In some embodiments, the relatively short time period and the relatively long time period can be discreet time periods related to, for example, different test substances or the same test substance. In some embodiments, the short time period can be a subset of the long time period (related to a single test substance).

Line 20 through line 23 represent combinations of parameters across the category D₁, category D₂, and category D_{N} shown in FIG. 2A. For example, line 23 represents a combination of parameters that includes parameter E₁, parameter F₁, and parameter G₁. Line 20 represents a combination of parameters that includes parameter E₃, parameter F₃, and parameter G₂. The combinations of parameters can be referred to by the lines that represent the combinations of parameters. For example, the combination of parameters represented by line 20 can be referred to combination of parameters 20, or as parameter combination 20.

One or more statistical values can be calculated based on one or more of the combinations of parameters represented by (e.g., exemplified by) lines 20 through 23 and based on relationship rules selected from the relationship rules 35. The relationship rules 35 can define a manner (e.g., an order, an algorithm) in which statistical value(s) are to be defined based on test value(s) associated with combination(s) of parameters. The statistical values can be, for example, mathematical combinations or aggregations of the test values.

For example, a statistical value can be calculated based on test values associated with the combination of parameters 20 and the relationship rule 30. The relationship rule 30 can be selected from the relationship rules 35 based on the combination of parameters 20 (e.g., based on the type of parameters included in the combination of parameters). Specifically, the statistical value can be calculated based on a test values associated with test substances represented by the combination of parameters 20 (which can represent a combination of characteristics). In this case, the parameters included in the combination of parameters 20 are terminating parameters. The test values associated with test substances related to the combination of parameter E₃, parameter F₃, and parameter G₂ can be used to define a statistical value. In some embodiments, multiple test substances may have test values related to this combination of parameters 20. The relationship rule 30 can define a manner in which the multiple test values associated with the multiple test values should be combined to define the statistical value. In some embodiments, the relationship rule 30 can indicate that the test values should be used to calculate an average value, a standard deviation value, percentile rankings, cell distributions, and/or so forth. In some embodiments, the parameters within the combination of parameters 20 can be selected by, for example, a user (e.g., a user-trigger interaction) via a user interface (not shown).

In some embodiments, one or more of the relationship rules 35 can be defined by one or more users (e.g., scientists). For example, a user can define a new relationship rule (e.g., conditions associated with the new rule) based on information (e.g., know-how, knowledge) acquired during an experiment; published in a scientific book, journal, or catalog; and/or otherwise communicated. In some embodiments, threshold limits, conditions, filters, etc. associated with the new relationship rule can be defined by the user via a user interface (not shown). In some embodiments, one or more of the relationship rules 35 can be defined based on, for example, information related to commonly used sets of reagents within a given test substance.

In other words, one or more of the relationship rules 35 can be defined based on a know-how and/or empirical data. In some embodiments, the relationship rules 35 can be defined based on information (e.g., empirical data/information) included in a knowledge database. In some embodiments, relationship rules 35 can represent interactions between attributes represented by parameters within the categories. In other words, the relationships rules 35 can be defined so that they trigger calculations of statistical values that are representative of, or correspond with, biological interactions associated with attributes represented by parameters included in a combination of parameters.

In some embodiments, an indicator can be defined based on the relationship rules 35. For example, in some embodiments, an indicator (e.g., a color indicator, a numerical indicator, a graphical indicator) that a statistical value calculated based on the combination of parameters 20 is above (or below) an expected threshold value can be defined based on the relationship rule 35. The indicator can be displayed on, for example, a graphical user interface so that a user can readily determine based on the indicator that the statistical value calculated based on the combination of parameters 20 is above (or below) the expected threshold value. In some embodiments, a shape, a size, a location, and/or so forth of the indicator can be defined based on one or more of the relationship rules 35.

In some embodiments, one or more of the combinations of parameters 20 through 23 can be modified. For example, the combination of parameters 21 can be changed so that the combination of parameters 21 includes different parameters. In some embodiments, one or more parameters can be removed from the combination of parameters 21. In some embodiments, one or more parameters can be added to the combination of parameters 21 from one or more of the categories shown in FIG. 2A (or from a category not shown in FIG. 2A). In some embodiments, one or more parameters can be added by and/or removed by, for example, a user (e.g., a user-trigger interaction) via a user interface (not shown). In some embodiments, the parameter(s) can be added or can be removed by expanding or contracting, respectively, a portion of a graphical representation of one or more combinations of parameters in a hierarchical structure.

In some embodiments, an indicator reflecting a change in a combination of parameters can be defined. For example, a first combination of parameters can be defined by a user. A first indicator can be defined based on a first statistical value calculated based on the first combination of parameters. If the first combination of parameters is modified to define a second combination of parameters (different than the first combination of parameters), a second indicator (different than the first indicator) can be defined based on a second statistical value calculated based on the second combination of parameters. The first statistical value and the second statistical value can be calculated based on the same relationship rule. In some embodiments, the first statistical value can be calculated based on a first relationship rule selected from a library of relationship rules based on the parameters included in the first combination of parameters, and the second statistical value can be calculated based on a second relationship rule (different from the first relationship rule) selected from the library of relationship rules based on the parameters included in the second combination of parameters.

In some embodiments, different indicators (and/or aspects of indicators) can be defined based on different relationship rules (from the relationship rules 35). For example, a first indicator can be defined for a statistical value based on a first relationship rule, and a second indicator (different from the first indicator) can be defined for the same statistical value based on a second relationship rule (different from the first relationship rule). In some embodiments, a first portion of an indicator can be defined based on a first relationship rule and a second portion of the indicator can be defined based on a second relationship rule.

In some embodiments, relationship rule 31 can be used to calculate a statistical value based on test value(s) associated with the combination of parameters 21. The relationship rule 31 can be selected based on the hierarchical position of one or more of the parameters within their respective hierarchical structures. For example, in some embodiments, the relationship rule 31 can be selected because the combination of parameters 21 includes parameter G₃, which is at hierarchical level 25 within the hierarchical structure of the set of parameters of category D_{N}. Although not shown, in some embodiments, a statistical value related to the combination of parameters 20 could also be calculated based on relationship rule 31 because parameter G₂ is also at hierarchical level 25. In some embodiments, for example, the relationship rule 31 can be selected because at least one of the parameters is a terminating parameter. As shown in FIG. 2A, the relationship rule 32 is selected for calculation of a statistical value for the combination of parameters 22 because the combination of parameters 22 includes parameter G₁ which is at hierarchical level 24. If the combination of parameters 22 included parameter G₃ (not shown in FIG. 2A) instead of parameter G₁, the relationship rule 31 (rather than relationship rule 32) could have been selected and used to calculate a statistical value for the combination of parameters 22.

In some embodiments, statistical values calculated based on a relationship rule that is selected based one or more hierarchical positions can correlate with the hierarchical position(s).

For example, a relationship rule can be selected from the relationships rules 35 based on a combination of parameters that includes non-terminating parameters (e.g., only non-terminating parameters). The combination of parameters can be associated with test values that can be used to define a statistical value based on the selected relationship rule. The relationship rule can be defined (e.g., defined based on scaling of the test values) so that the statistical value will reflect the fact that the combination of parameters are non-terminating parameters. In some embodiments, for example, a relationship rule can be selected from the relationships rules 35 based on a combination of parameters that includes only terminating parameters. The combination of parameters can be associated with test values that can be used to define a statistical value based on the selected relationship rule. The relationship rule can be defined so that the statistical value will reflect the fact that the combination of parameters includes only terminating parameters.

As shown in FIG. 2A, the combination of parameters 20 is a subset of the combination of parameters 23 because each of the parameters included in the combination of parameters 20 is hierarchically related (at a lower hierarchical level) to at least one of the parameters from the combination of parameters 23. For example, parameter G₂, which is included in combination of parameters 20, is a child parameter of parameter G₁, which is included in combination of parameters 23. Similarly, parameter F₃, which is included in combination of parameters 20, is a grandchild parameter of parameter F₁, which is included in combination of parameters 23. The combination of parameters 20 can be referred to as a subset combination of parameters (or as a subset parameter combination) of the combination of parameters 23, and the combination of parameters 23 can be referred to as a superset combination of parameters (or as a superset parameter combination) of the combination of parameters 20. As shown in FIG. 2A, the combination of parameters 21 and the combination of parameters 22 are also subset combinations of parameters of the combination of parameters 23.

If a combination of parameters includes one or more non-terminating parameters, test values associated with subsets of parameter combinations (and include terminating parameters) relative to the combination of parameters can be used to calculate one or more statistical values. In some embodiments, the test values can be associated with subsets of parameter combinations that have only terminating parameters. For example, a test value associated with combination of parameters 20 and a test value associated with combination of parameters 21 can be used to calculate a statistical value associated with the combination of parameters 23, which is a superset of both the combination of parameters 20 and the combination of parameters 23. This type of combination of test values associated with subsets of parameter combinations can be referred to as an aggregation of the test values.

In some embodiments, a relationship rule selected from the relationship rules 35 can be used to define statistical values based on subsets of parameter combinations. For example, as shown in FIG. 2A, a statistical value can be calculated for the combination of parameters 22 based on relationship rule 32 and based on test values respectively associated with parameter combination 20 and parameter combination 21 (which are subsets of parameter combinations relative to combination of parameters 22). As shown in FIG. 2A, combination of parameters 20 through 22 each include parameter E₃ from category D₁ and parameter F₃ from category D₂ (which are both terminating parameters). The parameters from category D_{N} for each of the combination of parameters 20 through 22, however, are different. The combination of parameters 22, which is included in the superset combination of parameters, includes parameter G₁ from category D_{N}. The combination of parameters 20 includes parameter G₂ (from category D_{N}), which is a child of a parameter G₁, and the combination of parameters 21 includes parameter G₃ (from category D_{N}), which is also a child of a parameter G₁.

The test value(s) associated with combination of parameters 20 and the test value(s) associated with combination of parameters 21 can be combined to define a statistical value for combination of parameters 23 based on weighting factors (e.g., equal weighting factors). For example, the test value(s) associated with the combination of parameters 21 can be multiplied by a first weighting factor before being mathematically combined with (e.g., added to, averaged with) the test value(s) associated with the combination of parameters 20. The weighting can depend on, for example, the relative importance of child parameter G₂ within the parent parameter G₁, and the relative importance of child parameter G₃ within the parent parameter G₁. Specifically, if the category D_{N} represents a protein category, the child parameter G₂ and the child parameter G3 can represent individual proteins within certain signaling pathways. If the protein represented by child parameter G₂ and the protein represented by child parameter G₃ are correlated (as determined based on historical data or empirical data), a statistical value can be calculated based on equally weighted test values related to subset parameter combinations that include child parameter G₂ or child parameter G₃. If the protein represented by child parameter G₂ and the protein represented by child parameter G₃ are not correlated (as determined based on historical data or empirical data), a statistical value can be calculated based on a first weighting factor related to subset parameter combinations that include child parameter G₂ and a second weighting factor (different than first weighting factor) related to subset parameter combinations that include child parameter G₃. The manner in which these statistical values are calculated can be defined within (e.g., represented within) relationship rule 32, which is associated with the superset combination of parameters 22. In some embodiments, the relationship rule 32 can be defined to trigger calculation of a statistical value based on an equation, an algorithm, and/or so forth.

In some embodiments, a first relationship rule can be (selected and) used to calculate statistical values for subsets of parameter combinations, and a second relationship rule can be (selected and) used to calculate one or more statistical values for supersets of parameter combinations (that include the subsets of parameter combinations) based on the statistical values calculated based on the first relationship rule. For example, a first statistical value can be calculated for parameter combination 20 based on relationship rule 30 and a second statistical value can be calculated for parameter combination 21 based on relationship rule 31. The relationship rule 30 and the relationship rule 31 can be the same or different. A third statistical value can be calculated for parameter combination 22, which is a superset parameter combination relative to parameter combination 20 and parameter combination 21, using the first statistical value and the second statistical value based on relationship rule 32.

In some embodiments, one or more of the relationship rules 35 can be defined to trigger calculation of a statistical value based on interactions between biological attributes represented by parameters within different hierarchical structures. For example, a relationship rule 35 can be defined to trigger a calculation of a statistical value based on an interaction between a biological attribute represented by parameters that define a hierarchical structure within category D₁ and a biological attribute represented by parameters that define a different hierarchical structure within category D_{N}. Specifically, category D₁ can represent a modulator category that includes a set of parameters within a hierarchical structure of inhibitors and/or growth factors, and category D_{N} can represent a protein category that includes a set of parameters within a different hierarchical structure representing pathways and proteins included in those pathways. In some embodiments, for example, a statistical value can be calculated based on a combination (e.g., a sum, a maximum, a minimum, an average) test value (as defined by at least one of the relationship rules 35) from test values associated with subsets of parameter combinations that each include inhibitor parameters (from the modulator category D₁) that are known to act on (or to not act on) a single, common protein parameter (from the protein category D_{N}), or particular combination of protein parameters. In sum, a statistical value for a superset parameter combination can be calculated based on test values associated with subsets of parameter combinations (from the superset parameter combination) that have certain parameters within a first category if the certain parameters have an effect on parameters within a second category. In such instances, relationship rule(s) can be selected from the relationship rules 35 to trigger the calculation of the statistical value in a desirable fashion (e.g., in a fashion that represents or corresponds with the biological interactions). In some embodiments, the relationship rule(s) can be selected based on the parameters (or known interactions between biological attributes represented by parameters) included in the superset combination of parameters.

One or more of the relationship rules 35 can be configured to trigger a calculation of a statistical value for a superset parameter combination based on only certain test values from subsets of parameter combinations (of the superset parameter combination) and not on test values from other subsets of parameter combinations (of the superset parameter combination) based on, for example, biological interactions between attributes represented by parameters included in the protein category and attributes represented by parameters included in the modulator category. In some embodiments, a statistical value for a superset parameter combination can be calculated based on test values (as defined by at least one relationship rule 35) associated with only subsets of parameter combinations (included in the superset parameter combination) that each include inhibitor parameters that are known to act on a target protein parameter. Test values associated with subsets of parameter combinations (included in the superset parameter combination) that include inhibitor parameters that are known not to act on a target protein parameter may not be used to calculate the statistical value. Thus, a statistical value for a superset parameter combination can be calculated based on test values associated with only a portion of the subsets of parameter combinations within the superset parameter combination. In such instances, relationship rule(s) can be selected from the relationship rules 35 to trigger the calculation of the statistical value in a desirable fashion (e.g., in a fashion that represents or corresponds with the biological interactions). In some embodiments, the relationship rule(s) can be selected based on the parameters (or known interactions between biological attributes represented by parameters) included in the superset combination of parameters.

In some embodiments, statistical values calculated based on more than one combination of parameters can be compared. For example, in some embodiments, a relationship rule from the relationship rules 35 can be used to calculate, for example, a co-variance value based on statistical values calculated based on different combinations of parameters. For example, a co-variance value(s) can be calculated based on a statistical value(s) related to combination of parameters 20 and a statistical value(s) related to combination of parameters 21. In this case, the combination of parameters 20 and the combination of parameters 21 include parameters that are at the same hierarchical levels within each of the categories. In some embodiments, a co-variance value(s) can be calculated based on a statistical value(s) related to combinations of parameters that may be hierarchically related (e.g., may have a subset/superset relationship).

In some embodiments, one or more of the relationship rules 35 can be configured to calculate a statistical value based on a user preference. For example, more than one relationship rule (from the relationship rules 35) may be used to calculate a statistical value based on a particular parameter combination. In such instances, a user can manually select which of the relationship rules should be used to calculate the statistical value(s). In some embodiments, the relationship rules to be used to calculate one or more statistical value(s) based on a particular combination of parameters can be selected based on user preference (e.g., a pre-defined user preference). In some embodiments, the user preference can be stored at and/or accessed at a bioinformatics analysis module such as that shown in FIG. 1A.

In some embodiments, one or more of the relationship rules 35 can be a user-specific rule. For example, one or more of the relationship rules 35 can be defined by a specific user and/or retrieved for use for a specific user. Moreover, the relationship rules 35 can be selected based on an identifier (e.g., a username) associated with a user. The identifier can be determined in response to a login process.

In some embodiments, one or more of the relationship rules 35 can be defined so that an action, in addition to, or in lieu of calculation of a statistical value, can be performed in response to a condition associated with the relationship rule(s) 35 being satisfied (or unsatisfied). For example, a bioinformatics analysis module (such as that shown in FIG. 1A) can be configured to send a notification to a user when a combination of parameters may include parameters that conflict (e.g., conflict biologically, conflict chemically) with one another and/or when test values associated with subsets of parameter combinations may not be used to calculate a statistical value.

In some embodiments, conflicts between relationship rules 35 can be resolved based on conflict rules (not shown). In some embodiments, for example, conflict rules can be defined so that one of the relationship rules 35 can take priority over another of the relationship rules 35. In some embodiments, conflicts between the relationship rules 35 can be handled based on a priority value associated with the relationship rules 35. For example, if a first relationship rule from relationship rules 35 would define a statistical value in a different way than a second relationship rule from the relationship rules 35, the first relationship rule can be applied instead of the second relationship rule if the first relationship rule has a higher priority value than a priority value associated with the second relationship rule. In some embodiments, the priority values associated with the relationship rules 35 can be dynamically defined based on an identity of a user. In other words, this type of conflict can be resolved by a conflict rule included in a user preference.

In some embodiments, a relationship rule can be selected from the relationship rules 35 based on an annotation value and/or a relationship rule that is associated with a parameter. FIG. 2B is a schematic diagram that illustrates annotation values and relationship rules associated with a parameter, according to an embodiment. Specifically, FIG. 2B illustrates annotation values 28 and relationship rules 27 associated with parameter G₁ (which is from category D_{N} shown in FIG. 2B). The annotation values 28 and/or the relationship rules 27 can function as metadata of the parameter G₁. In some embodiments, the annotation values 28 can be biological attributes (e.g., biological characteristics), measurement values, notations, and/or so forth related to the parameter G₁ that are not part of a hierarchical structure that includes parameter G₁.

In some embodiments, the relationship rules 27 can be associated with parameter G₁, so that the relationship rules 27 can be used to define a statistical value for a combination of parameters that includes parameter G₁. For example, relationship rule Q can be used to calculate a statistical value for a combination of parameters that includes parameter G₁. In some embodiments, the relationship rule Q can be logically combined with a relationship rule that is selected from the relationship rules 35 for calculation of a statistical value for the combination of parameters. In other words, the relationship rule Q specifically associated with parameter G₁ can be (or can define) a component of a relationship rule (e.g., an overarching relationship rule) for calculation of a statistical value for the combination of parameters.

In some embodiments, a relationship rule can be selected from the relationship rules 35 based on one or more of the annotation values 28. For example, a relationship rule can be selected from the relationship rules 35 (shown in FIG. 2A) based on a combination of parameters that includes parameter G₁ because parameter G₁ is associated with annotation value X.

Referring back to FIG. 2A, in some embodiments, one or more of the hierarchical structures shown in FIG. 2A can be modified. In such instances, the hierarchical relationships of parameters within combinations of parameters can be changed. For example, if a new hierarchical parameter is included in a category—resulting in regrouping of certain parameters—the hierarchical position of one or more parameters within a combination of parameters can be changed.

In some embodiments, selection of relationship rules from the relationship rules 35 can be affected based on changes in one or more hierarchical structures of one or more categories. For example, a combination of parameters can include parameters that have a first set of hierarchical positions within hierarchical structures associated with several categories. The first set of hierarchical positions of one or more parameters from the combination of parameters can be changed to a second set of hierarchical positions when one or more of the hierarchical structures associated with the categories are changed. A first relationship rule can be selected for calculation of a statistical value based on the first set of hierarchical positions (and/or combination of parameters), and a second relationship rule (different from the first relationship rule) can be selected for calculation of a statistical value based on the second set of hierarchical positions (and/or combination of parameters).

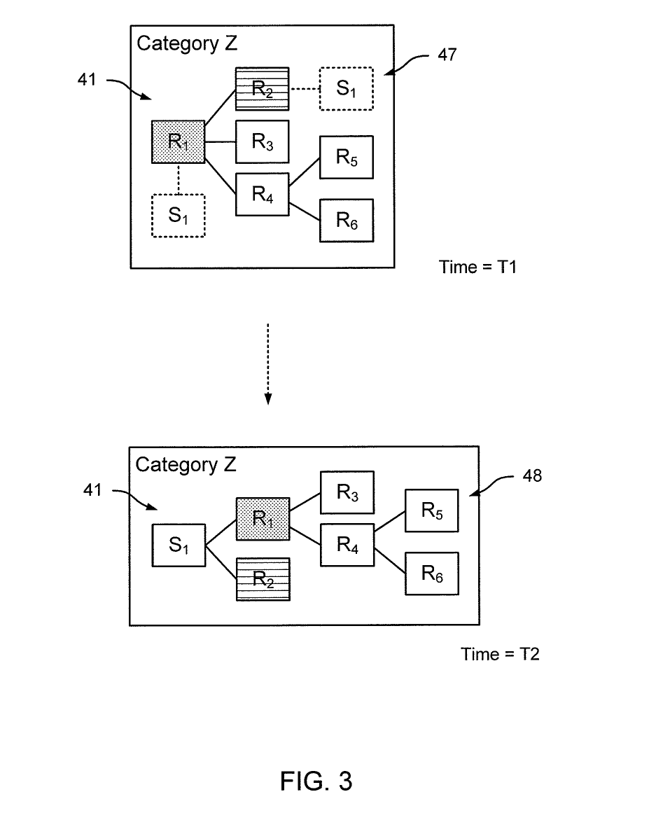

In some embodiments, a hierarchical structure of a category can be modified based on, for example, using annotation values associated with one or more of parameters. More details related to changing a hierarchical structure based on annotation values is shown in FIG. 3.

FIG. 3 is a schematic diagram that illustrates a hierarchical structure of a set of parameters modified based on an annotation value, according to an embodiment. As shown in FIG. 3, a set of parameters 41 included in category Z defines a first hierarchical structure 47 at time T1, and the set of parameters 41 is changed to define a second hierarchical structure 48 at time T2.

As shown in FIG. 3, the change from the first hierarchical structure 47 to the second hierarchical structure 48 is based on an annotation value S₁. As shown in the first hierarchical structure 47, the annotation value S₁ is associated with parameter R₁ and parameter R₂, and parameter R₁ is at the highest hierarchical level of the first hierarchical structure 47. But, the annotation value S₁ is not included in the first hierarchical structure 47 as represented by the dashed lines.

As shown in the second hierarchical structure 48, the annotation value S₁ is at the highest hierarchical level and parameter R₁ and parameter R₂ are child parameters from the annotation value S₁. As shown in FIG. 3, the annotation value S₁ is changed from an annotation value S₁ in the first hierarchical structure 47 to a parameter within the second hierarchical structure 48 (as represented by the solid lines). In some embodiments, the change in hierarchical structure can be triggered by a user, for example, via a user interface of a bioinformatics analysis module such as that shown in FIG. 1A.

In some embodiments, changes in hierarchical structure (such as that shown in FIG. 3) of a set of parameters can result in parameters from a combination of parameters to have a changed hierarchical position. The changed hierarchical position can trigger a bioinformatics analysis module (such as that shown in FIG. 1A) to select and use a relationship rule to calculate a statistical value that would not otherwise be selected and used to calculate the statistical value had the hierarchical position not changed. For example, a first relationship rule can be selected based on a combination of parameters that includes parameter R₁ because parameter R₁ has a specified hierarchical position within the hierarchical structure 47. The first relationship rule can be used to calculate a statistical value based on a test value associated with the combination of parameters. A second relationship rule different from the first relationship rule can be selected based on the combination of parameters (and used to calculate a statistical value) when the hierarchical position of the parameter R₁ is changed to the hierarchical position shown in the second hierarchical structure 48.

As shown in FIG. 3, the parameter R₂ is at the same hierarchical level in the first hierarchical structure 47 and the second hierarchical structure 48. Accordingly, in some embodiments, the change in hierarchical structure of the set of parameters in category Z from the first hierarchical structure 47 to the second hierarchical structure 48 may not alter selection of a relationship rule based on a combination of parameters that includes parameter R₂. The hierarchical relationships between the parameter R₂ and other parameters from the set of parameters included in category Z are different. Accordingly, in some embodiments, the change in the hierarchical relationships of the set of parameters in category Z from the first hierarchical structure 47 to the second hierarchical structure 48 may trigger modification of a selection of a relationship rule based on a combination of parameters that includes parameter R₂.

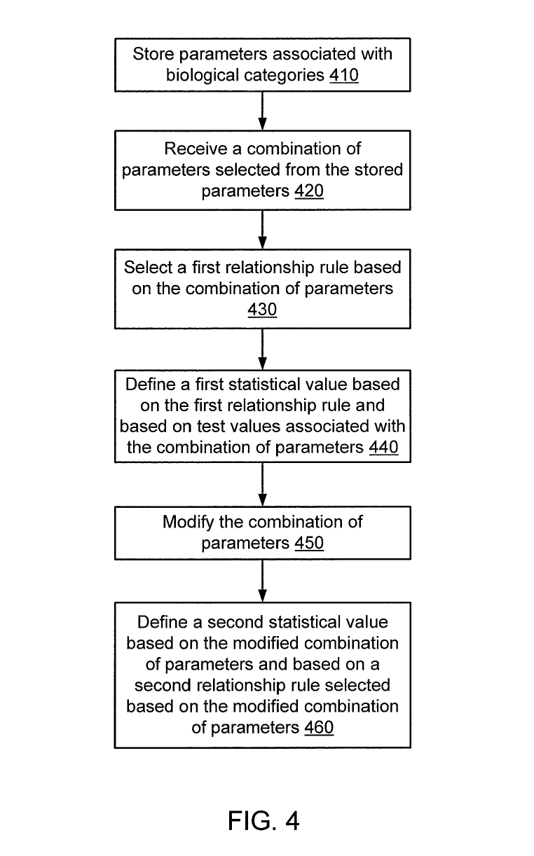

FIG. 4 is a flowchart that illustrates a method for calculating statistical values based on relationship rules, according to an embodiment. As shown in FIG. 4, parameters associated with biological categories are stored, at 410. In some embodiments, the biological categories can include, for example, a protein category, a specimen category, and so forth. In some embodiments, the parameters included in the biological categories can define hierarchical structures within the biological categories. For example, a set of parameters included in a particular biological category can define a hierarchical structure that has several hierarchical levels. In some embodiments, the parameters associated with the biological categories can be stored in a bioinformatics database. In some embodiments, the parameters can be related to, for example, test substances associated with a flow cytometry experiment.

A combination of parameters selected from the stored parameters is received, at 420. In some embodiments, the combination of parameters can be selected by a user based on a clinical experiment or other type of experiment. In some embodiments, the combination of parameters can include parameters from multiple biological categories. In some embodiments, the combination of parameters can be associated with one or more test substances. In some embodiments, the combination of parameters can include two or more parameters.

A first relationship rule is selected based on the combination of parameters, at 430. In some embodiments, the first relationship rule can be selected based on one or more of the hierarchical positions (e.g., hierarchical levels, hierarchical relationships) of the parameters from the combination of parameters. In some embodiments, the first relationship rule can be selected based on the type of parameters included in the combination of parameters. In some embodiments, the first relationship rule can be selected based on one or more annotation values associated with one or more of the parameters included in the combination of parameters. In some embodiments, the first relationship rule can be selected and/or defined based on biological interactions between attributes represented by one or more of the parameters included in the combination of parameters.

A first statistical value can be defined based on the first relationship rule and based on test values associated with the combination of parameters, at 440. In some embodiments, the combination of parameters can be associated with a single test value associated with a single test substances. In some embodiments, the first statistical value can be defined based on, for example, an average or standard deviation of the test values.

The combination of parameters is modified, at 450. In some embodiments, the combination of parameters can be modified by a user via a user interface associated with a bioinformatics analysis module. In some embodiments, the combination of parameters can be modified when a hierarchical structure related to at least one of the parameters included in the combination of parameters is changed.

A second statistical value is defined based on the modified combination of parameters and based on a second relationship rule selected based on the modified combination of parameters, at 460. In some embodiments, the second relationship rule can be different than the first relationship value. The second relationship rule can be selected based on, for example, one or more hierarchical structures associated with the modified combination of parameters (which may be different than the hierarchical structure(s) associated with the combination of parameters before the modification of the combination of parameters). In some embodiments, the modified combination of parameters can be a subset or superset of the combination of parameters before the modification of the combination of parameters.

In some embodiments, the methods and apparatus described herein can be used to calculate and/or determine, for example, cell distributions (based on individual cell measurements) that can be captured using clustering (e.g. expectation maximization), fingerprinting (e.g. flow fingerprinting from CIRA), shifts in cell distribution, comparisons between test substances (e.g., comparisons of cell distribution levels, aggregated level median fluorescent intensity (MFI) values, and/or so forth between test substances of normal/healthy donors and test substances of diseased donors). Calculating a signaling level related to MFI can include, for example, obtaining a first median fluorescent intensity of a basal sample (MFI_{basal}) and a second median fluorescent intensity of a modulated sample (MFI_{mod}) such as through the use of flow cytometer analysis. Next the fold change can be calculated by dividing MFI_{mod} by MFI_{basal}. In some embodiments, an indicator of signaling level intensity can be provided, wherein the signaling level intensity indicator is generated by comparing said calculated fold change to a normative or basal signaling level. The signaling level intensity can be correlated to combinations of parameters that can include, for example, at least one modulator, at least one detection element, a sample, and optionally to a pathway and stored in a database. These calculations can be based on one or more relationship rules.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, compact flash (CF) devices, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

In some embodiments, a bioinformatics analysis module and/or any portion of the embodiments described herein can be executed at (e.g., implemented on) a computer. In some embodiments, a computer can be used by to operate various instrumentation, liquid handling equipment and/or analysis software. The computer can have any type of computer platform such as a workstation, a wireless device, a wired device, a mobile device (e.g., a PDA), a personal computer, a server, and/or any other present or future electronic device and/or computer. The computer can include, for example, components such as a processor, an operating system, a system memory, a memory storage device, input-output controllers, input-output devices, and/or display devices. Display devices can be configured to display visual information that may be may be logically and/or physically organized as an array of pixels. A GUI controller may also be included that may include any of a variety of known or future software programs for providing graphical input and output interfaces such as for instance GUI's. For example, GUI's may provide one or more graphical representations to a user, and also be enabled to process the user inputs via GUI's using means of selection or input known to those of ordinary skill in the related art. For example, see U.S. Ser. No. 61/048,657, which is incorporated by reference in its entirety.

A computer can have many possible configurations of components and some components that may typically be included in a computer are not shown, such as a cache a memory, a data backup unit, and/or many other devices. The processor can be a commercially available processor such as an Itanium® or Pentium® processor made by Intel Corporation, a SPARC® processor made by Sun Microsystems, an Athlon™ or Opteron™ processor made by AMD corporation, or it may be one of other processors that are or will become available. Some embodiments of the processor may also include what are referred to as Multi-core processors and/or be enabled to employ parallel processing technology in a single or multi-core configuration. For example, a multi-core architecture typically can include two or more processor such as “execution cores.” In the present example, each execution core may perform as an independent processor that enables parallel execution of multiple threads. In addition, the processor may be configured in what is generally referred to as 32 or 64 bit architectures, or other architectural configurations now known or that may be developed in the future.

The processor executes operating system, which may be, for example, a Windows®-type operating system (such as Windows® XP) from the Microsoft Corporation; the Mac OS X operating system from Apple Computer Corp. (such as Mac OS X v10.4 “Tiger” or Mac OS X v10.5 “Leopard” operating systems); a Unix® or Linux-type operating system available from many vendors or what is referred to as an open source; another or a future operating system; or some combination thereof. In some embodiments, the operating system can be configured to interface with firmware and hardware in various manners, and facilitate a processor in coordinating and executing the functions of various computer programs that may be written in a variety of programming languages. The operating system can be configured to cooperate with the processor, coordinate and execute functions of the other components of computer. The operating system can also be configured to provide scheduling, input/output control, file and data management, memory management, and/or communication control and related services.

In some embodiments, a memory can be used in conjunction with the embodiments described herein. The memory may be any of a variety of known or future memory storage devices. Examples include any available random access memory (RAM), magnetic medium such as a resident hard disk or tape, an optical medium such as a read and write compact disc, or other memory storage device. Memory storage devices may be any of a variety of known or future devices, including a compact disk drive, a tape drive, a removable hard disk drive, USB or flash drive, or a diskette drive. Such types of memory storage devices can be configured to read from, and/or write to, a program storage medium (not shown) such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, can be stored in system memory and/or the program storage device used in conjunction with memory storage device.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. One or more processor-readable media storing code representing instructions that when executed by one or more processors cause the one or more processors to:
select a first relationship rule based on a first combination of parameters including a first parameter and based on a hierarchical position of the first parameter within a hierarchical structure of a set of parameters from a biological category;
define a first statistical value based on a plurality of test values and based on the first relationship rule; and
define a second statistical value based on a second relationship rule different from the first relationship rule and based on a second combination of parameters, the second relationship rule being selected based on a hierarchical position of the second parameter within the hierarchical structure of the set of parameters, the first parameter being different than the second parameter, the first combination of parameters having a portion of parameters equal to a portion of parameters of the second combination of parameters.

2. The one or more processor-readable media of claim 1, wherein the first relationship rule represents a biological relationship between at least two parameters included in the first combination of parameters.

3. The one or more processor-readable media of claim 1, wherein the plurality of test values are associated with a plurality of test substances, the first relationship rule defines an order for combining the plurality of test values to define the first statistical value.

4. The one or more processor-readable media of claim 1, wherein the hierarchical structure has a plurality of terminating parameters from the set of parameters, the plurality of test values are related to the terminating parameters.

5. The one or more processor-readable media of claim 1, wherein the biological category is a first biological category, the hierarchical structure is a first hierarchical structure, the first relationship rule is selected based on a second hierarchical structure within a second biological category mutually exclusive from the first biological category.

6. The one or more processor-readable media of claim 1, wherein the biological category is from a plurality of biological categories, the plurality of biological categories includes at least one of a protein category, a reagent category, a kinetic category, or a specimen category.

7. The one or more processor-readable media of claim 1, wherein at least one of the first statistical value or the second statistical value is based on a fluorescence intensity value produced at a cytometry device.

8. The one or more processor-readable media of claim 1, wherein the first parameter and the second parameter are hierarchically related via the hierarchical structure of the set of parameters.

9. The one or more processor-readable media of claim 1, wherein the second statistical value is defined in response to a user-triggered selection of the second parameter.

10. The one or more processor-readable media of claim 1, wherein the first relationship rule includes a first weight factor associated with the hierarchical position of the first parameter, the second relationship rule includes a second weight factor associated with the hierarchical position of the second parameter, the first weight factor is different than the second weight factor.

11. One or more processor-readable media storing code representing instructions that when executed by one or more processors cause the one or more processors to:
define a first statistical value associated with a test substance based on a combination of parameters, a parameter from the combination of parameters having a hierarchical position within a hierarchical structure of a set of parameters included in a biological category;
receive an indicator that the hierarchical position of the parameter has changed when the hierarchical structure is changed such that an annotation value associated with the parameter is included in the hierarchical structure, the annotation value being excluded from the hierarchical structure before the hierarchical structure is changed; and
define a second statistical value different than the first statistical value based on the changed hierarchical position.

12. The one or more processor-readable media of claim 11, wherein the parameter is a first parameter, the annotation value is associated with a second parameter that is at a hierarchical level of the hierarchical structure that is different than a hierarchical level of the first parameter within the hierarchical structure.

13. The one or more processor-readable media of claim 11, wherein the first statistical value is defined based on relationship rule, the relationship rule is defined based on empirical data related to the combination of parameters.

14. The one or more processor-readable media of claim 11, wherein the biological category is from a plurality of biological categories, each parameter from the combination of parameters is associated with at least one biological category from the plurality of biological categories.

15. The one or more processor-readable media of claim 11, wherein the first statistical value is calculated based on a plurality of test values related to the parameter.

16. The one or more processor-readable media of claim 11, wherein the combination of parameters are retrieved from a bioinformatics database.

17. One or more processor-readable media storing code representing instructions that when executed by one or more processors cause the one or more processors to:
define a first statistical value associated with a test substance based on combination of parameters, each parameter from the combination of parameters being associated with at least one biological category from a plurality of biological categories, the plurality of biological categories including at least a protein category and a reagent category;
modify the combination of parameters such that a parameter from the combination of parameters before the modifying is hierarchically related to a parameter from the modified combination of parameters; and
define a second statistical value based on the modified combination of parameters.

18. The one or more processor-readable media of claim 17, wherein the statistical value is defined based on a first relationship rule, the second statistical value is defined based on a second relationship rule, the first relationship rule and the second relationship rule have a hierarchical relationship correlated with the hierarchical relationship between the parameter from the combination of parameters before the modifying and the parameter from the modified combination of parameters.

19. The one or more processor-readable media of claim 17, further storing code representing instructions that when executed by one or more processors cause the one or more processors to:
define a first indicator based on the first statistical value and based on a condition associated with the first statistical value; and
define a second indicator different from the first indicator based on the second statistical value and based on the condition.

20. The one or more processor-readable media of claim 17, wherein the plurality of biological categories includes a kinetic category.

21. The one or more processor-readable media of claim 17, wherein the plurality of biological categories includes a specimen category.

22. The one or more processor-readable media of claim 17, wherein each parameter from the combination of parameters is from a unique biological category from the plurality of biological categories.

23. The one or more processor-readable media of claim 17, wherein the statistical value is retrieved from a bioinformatics database.

24. The one or more processor-readable media of claim 17, further storing code representing instructions that when executed by one or more processors cause the one or more processors to:
retrieve a plurality of fluorescence values from a bioinformatics database based on the combination of parameters, the first statistical value is calculated based on the plurality of fluorescence values.
